(19) United States
(12) Patent Application Publication
(10) Pub. No.: US 2006/0193676 A1
(43) Pub. Date: Aug. 31, 2006

(54) Candy dispenser

(75) Inventor: Melvin J. Gordon, Chicago, IL (US)

Correspondence Address: George L. Greenfield;Wolf, Greenfield & Sacks, P.C., 600 Atlantic Avenue, Boston, MA, 02210-2206, US

(73) Assignee: Tootsie Roll Industries, Inc., Chicago, IL (US)

(21) Appl. No.: 11/067,387

(22) Filed: Feb. 25, 2005

(51) Int. Cl. B43K 21/02; A45D 40/04

(52) U.S. Cl. 401/55; 401/68

(57) ABSTRACT

A device for storing and dispensing candy includes a base with a hollow interior portion, a handle rotatably mounted to the base, and a threaded rod disposed at least partially within the base and movable relative to the handle and the base in at least one axial direction, and a holder disposed within the hollow interior portion of the base engaged with the threaded rod, and movable in at least one axial direction. In one embodiment, the candy dispenser comprises a base having a hollow interior portion, a threaded rod disposed at least partially within the base, a handle rotatably mounted to the base and rotatable relative to the threaded rod, and a holder disposed within the hollow interior portion of the base engaged with the threaded rod, and movable in at least one axial direction.

### BACKGROUND OF INVENTION

1. Field of Invention

This invention relates to a device and method for dispensing candy.

2. Description of Related Art

A multitude of containers have been developed in the past for the storage and dispensing of candy and similar consumable food products. Such dispensing containers have used various means to remove candy from the container for consumption. For example, candy may be attached to a stick-like device that protrudes from the container such that by pulling on the stick-like device, the individual can remove the candy from the container. In another example, candy may be deposited within a container that includes a plunger-type device that can be pushed on one side such that the other side of the plunger-type device forces the candy through an opening in the container. Candy dispensers have also included levers or buttons that, when manipulated, force a portion of candy from the container for consumption. Candy dispensers are often developed with a target market of children in mind. As such, the dispensers are usually designed for easy manipulation by small children, and may often take the form of various shapes, animals or characters to increase the attractiveness of the dispenser for children. Various dispensing devices of the prior art allow the user to dispense only a desired amount of candy while storing the remainder for consumption at a later time.

U.S. Pat. No. 6,099,873 to Coleman et al. discloses, from the abstract, “[a] candy holder candy twister including a main housing in which a piece of candy contained on a hollow sleeve is removed from the housing for consumption by a threaded shaft. The threaded shaft moves the candy piece as the shaft is rotated.”

### SUMMARY OF THE INVENTION

The inventors of the candy dispenser herein disclosed have developed a device that allows for easy dispensing of a set portion of candy from the container, and the ability to retract any unconsumed portion of the candy back into the container. In this manner, the candy device allows consumption of a limited amount of the entire candy, if desired, while reducing waste by saving unconsumed portions of candy for another time. Additionally, the inventors have developed a device that minimizes the opportunities for the candy to come into direct contact with a child's hands, as well as lessens the chances of direct contact of the candy with clothing and other surfaces that could result in either candy residue on these surfaces or contamination of the candy caused by contact with such surfaces.

In one embodiment, a candy dispenser comprises a base having a hollow interior portion, a first end portion and a second end portion, and an axis from the first end portion to the second end portion. The candy dispenser also comprises a handle rotatably mounted to the base and comprising a threaded nut portion, and a threaded rod disposed at least partially within the base and operably coupled to the threaded nut portion. The threaded rod is movable through the threaded nut portion in at least one axial direction and movable relative to the handle in at least one axial direction. The candy dispenser further comprises a holder disposed within the hollow interior portion of the base and engaged with the threaded rod, wherein the holder is movable in at least one axial direction.

In another embodiment, a candy dispenser comprises a base having a hollow interior portion, a first end portion and a second end portion, and an axis from the first end portion to the second end portion. The candy dispenser also comprises a threaded rod disposed at least partially within the base, the threaded rod operably coupled to and movable through the threaded nut portion in at least one axial direction. The candy dispenser also comprises a handle rotatably mounted to the base and comprising a threaded nut portion, wherein the handle is rotatable relative to the threaded rod. The candy dispenser further comprises a holder disposed within the hollow interior portion of the base and engaged with the threaded rod, wherein the holder is movable in at least one axial direction.

In a further embodiment, a candy dispenser comprises a base having a hollow interior portion, a first end portion and a second end portion, and an axis from the first end portion to the second end portion. The candy dispenser also comprises a handle rotatably mounted to the base and comprising a threaded nut portion. The candy dispenser also comprises a threaded rod disposed at least partially within the base, the threaded rod operably coupled to and movable through the threaded nut portion in at least one axial direction wherein the threaded rod is movable in at least one axial direction relative to the base. The candy dispenser further comprises a holder disposed within the hollow interior portion of the base and engaged with the threaded rod, wherein the holder is movable in at least one axial direction.

In still a further embodiment, a method of dispensing candy from a container comprises providing a base having a hollow interior portion containing candy, a first opening for dispensing candy and a second opening through which at least a portion of a threaded rod is passed to engage a candy holder, the first and second openings positioned along an axis of the base, the holder being coupled to the threaded rod such that the threaded rod and holder are movable in tandem within the base in an axial direction toward at least one of the first and second openings. The method of dispensing candy further comprises rotating a handle operably coupled to the threaded rod to move the rod and the holder in an axial direction toward the first opening such that at least a portion of the candy held in the holder protrudes beyond the first opening of the base.

In yet another embodiment, a pair of independently operable candy dispensers, each having its own base, are detachably connected together, and each base contains a candy holder, a handle rotatable on the base, a threaded rod coupled to the holder with both axially movable with respect to the base, and having a cap that may be independently removable from its base enabling the candy supported by the one holder to be separately consumed. The construction minimizes the candy in one housing, from coming into direct contact with the candy in the other and also avoids the hands or mouth of a person eating from one dispenser from coming into contact with the contents of the other dispenser.

### BRIEF DESCRIPTION OF THE DRAWINGS

Aspects of the invention are described in connection with the following illustrative drawings in which like numerals reference like elements, and wherein:

FIG. 1 is a perspective view of a candy dispenser according to one embodiment of the invention;

FIG. 2 is a top plan view of the candy dispenser of FIG. 1, with the dispenser cap removed;

FIG. 3 is an exploded perspective view of the candy dispenser of FIG. 1;

FIG. 4 is a cross-sectional view taken along line 4-4 in FIG. 1;

FIG. 5a is a schematic cross sectional side view of a candy dispenser with candy in a retracted position according to one embodiment;

FIG. 5b is a schematic cross-sectional side view of a candy dispenser with candy in a dispensing position according to one embodiment;

FIG. 5c is a schematic cross sectional side view of a candy dispenser with the candy at its maximum dispensed position;

FIG. 6 is a perspective view of a double candy dispenser in accordance with the present invention;

FIG. 7 is a top view thereof;

FIG. 8 is a cross-sectional view taken of the double dispenser taken along section line 8-8 in FIG. 7;

FIG. 9 is a perspective view of one of the base of one of the dispensers of the double dispenser shown in FIGS. 6-8; and

FIG. 10 is a top view of the base shown in FIG. 9.

### DETAILED DESCRIPTION

The present invention is directed to a device and method of dispensing candy. It should be appreciated that the use of the term “candy” throughout this description encompasses hard or soft candy, lollipop style candy, gum, chocolate, gelatin, as well as frozen or semi-frozen treats such as ice cream, frozen pops, and the like. The device 10 includes a dispenser base 40 to store candy 120, the candy being insertable through a top opening 42 of the base and seated on a candy holder 100 that is movable within the base. The device also includes a handle 20 that is coupled to a threaded rod 80, which in turn is coupled to the candy holder. By actuating the handle, a user of the device can move the threaded rod 80, and thus the candy holder 100, to move a desired quantity of candy from within the confines of the base and out through the top opening 42. Continued actuation of the handle causes an increasing amount of candy to be dispensed beyond the top opening of the base. The handle 20 may also be actuated to retract the candy from beyond the top opening back into the base container. The device further includes a cap 60 that fits over the opening 42 in the base 46 to protect the candy therein from external sources of contamination. It should be appreciated that the invention is not limited to the specific configurations and methods of dispensing described herein. The dispenser could be arranged, and the candy or like substance could be dispensed, in any of numerous ways within the scope of the present invention.

FIG. 1 shows an illustrative embodiment of a candy dispenser 10 incorporating aspects of the invention. In one embodiment, the candy dispenser 10 includes a base portion 40 for retaining candy, a handle 20 that may facilitate the dispensing of candy from an interior portion of the base 40, and a candy dispenser cap 60, as also shown separately in one embodiment in FIG. 3. The candy dispenser 10 may be made of plastic or other durable materials, and may be manufactured by any process known by one of ordinary skill in the art. Exemplary processes may include extrusion, cast molding, injection molding, and the like.

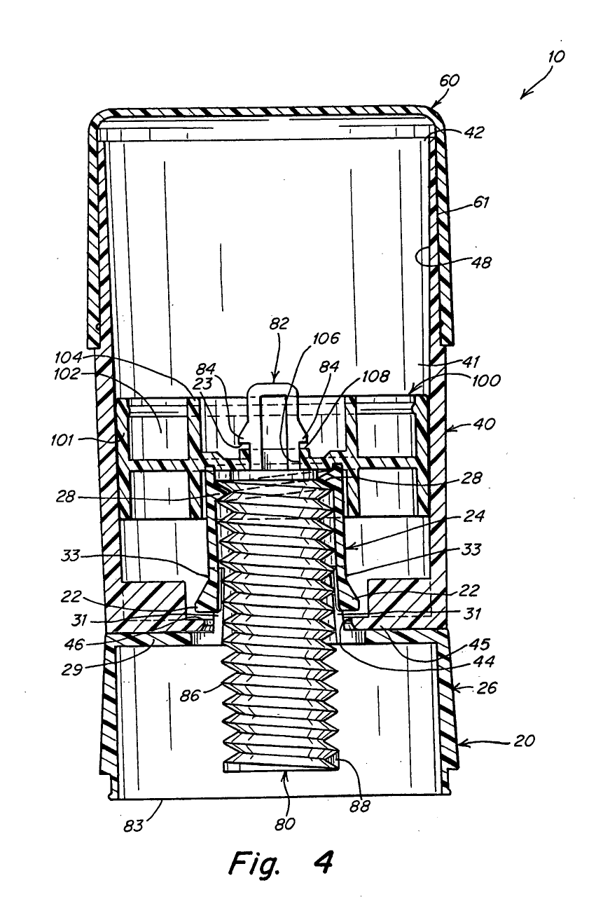

In one embodiment, the base 40, as shown in further detail in FIGS. 3 and 4, may include a hollow interior portion 41 for holding candy. While the shape of the base 40 according to one illustrative embodiment is a tube-like shape with essentially an elliptical cross-section, it should be appreciated that the base 40 container may have a circular, semi-circular, rectangular or other polygon cross section, or any other shape as would be appreciated by one of skill in the art. For example, the base 40 may take the form of an animal, character or figure, or a portion thereof, so long as there is some interior portion of the base to receive candy.

In another embodiment, the handle 20, also depicted in FIGS. 3 and 4, may include a hollow end portion 26, which in the embodiment of FIG. 1 is the externally visible portion of handle 20. The hollow end portion 26 open at the bottom 83 may be shaped to generally conform to the shape of the base 40. However, other shapes and sizes of the handle 20, as may be evident to one of skill in the art, may also be used within the scope of the present invention. Furthermore, the shape of the handle 20 need not conform to the shape of base 40. It should also be understood that the end portion 26 of the handle 20 need not be hollow as shown.

The end portion 26 has a sleeve 24 internally threaded at its upper end as shown at 28 in FIGS. 3 and 4, that extends upwardly from the top wall 29 of the end portion 26 of the handle. The sleeve 24 is connected to the wall 29 by a number of spaced posts 31 separated by spring latches 33 that carry outwardly extending flanges 22 at their lower ends 23. In the embodiment illustrated, four posts 31 are shown separated by four latches 33, but other numbers of posts and latches or other means for attaching the handle may be employed. The latches are somewhat flexible and, as explained more fully below, serve to connect the handle 20 to the base 40.

The handle 20 is assembled to the base 40 by inserting the sleeve 24 of the handle through the opening 44 in the base bottom wall 45 and forcing the latch flanges 22 past the opening 44. After passing through the opening 44, the latches spread to their biased circumferential dimension and are disposed above the rim 46 of the opening as shown in FIG. 4. Thus the wall 29 of the bottom portion 26 of the handle and the flanges 22 of the latches 33 trap the rim of the opening 44 to hold the handle 20 on the base 40, but the fit is loose enough to permit rotation of the handle on the base 40. It should be appreciated that the handle 20 may be secured to the base by other arrangements that allow for handle rotation. For example, the sleeve 24 and end portion 26 may be separately fabricated and attach together through the opening 44 by snaps, threads or other expedients.

In a further embodiment, the candy dispenser cap 60 may be configured and arranged to fit in close tolerance over the external surface 61 of the end of the base 40, so as to cover the top opening 42 (see FIG. 3) and frictionally engage the base 40. Alternatively, the cap 60 of the present invention may be secured to the base or by snaps, locks or other means known to those of skill in the art.

The candy dispenser 10 of the present invention may be sized to be hand-held, whether by an adult or child. However, the candy dispenser 10 may also be larger than is convenient for hand-held operation, and it may be easier to operate the dispenser by placing it on a countertop or other surface to dispense its candy.

In one aspect of the invention, the candy dispenser 10 includes a threaded rod 80 (see FIGS. 3 and 4) that may be disposed within the interior of the candy dispenser 10, and at least partially within the base 40. The threaded rod 80 may include a helical threaded portion 86, as well as a cap portion 82. In one embodiment, the threaded rod 80 may be inserted through the open bottom 83 of hollow end portion 26 of the handle 20 such that the cap portion 82 of the threaded rod 80 passes through the sleeve 24 of the handle 20. The sleeve may include a helically threaded portion 28 sized to mate with the threaded portion 86 of the rod 80.

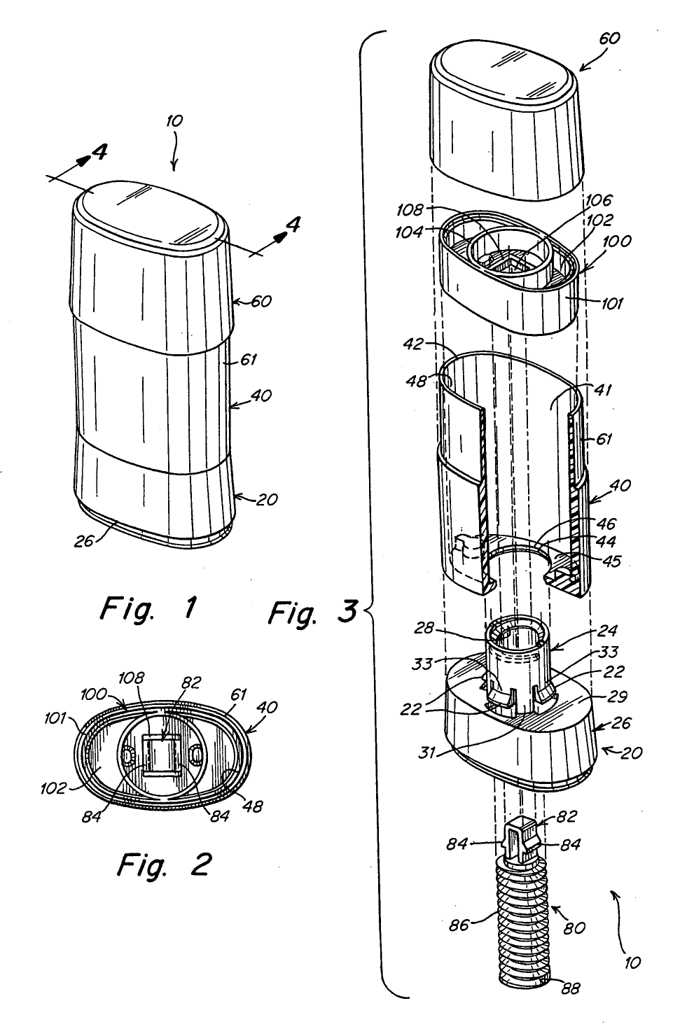

In another embodiment of the invention, the candy dispenser 10 may include a candy holder 100 as shown in FIGS. 2, 3 and 4 that may fit into the hollow interior portion 41 of the base 40, as depicted in FIG. 4. The candy holder 100 may act as a support for candy disposed in the base 40. The candy holder 100 may be positioned within the base 40 and have a central opening 106 that receives the cap portion 82 of the rod 80.

Engagement members 84 of the cap portion 82 of the threaded rod 80 may engage an interior surface 108 of the candy holder 100 to minimize relative movement between the rod and the candy holder. In this configuration, any axial movement of the rod 80 will cause the candy holder 100 to move in tandem with it. The candy holder 100 may also include a circular ring 104 within the interior of the candy holder 100 that delineates with the side wall 101 a candy holder portion 102 to support the bottom lower end of the candy inserted into the base 40. The circular ring 104 may also separate the cap portion 82 of the rod 80 from any candy that is inserted into the candy holder 100.

The candy dispenser 10 may also include means to limit the advance of the candy beyond the top opening 42 of the base 40. In one embodiment, the threaded rod 80 may include a thread stop 88 (see FIGS. 3 and 4) that, when engaged with the threads 28 in the sleeve 24, limits the axial movement of the rod 80 toward the top opening 42 of the base 40, and thus prevents the candy from advancing beyond a predetermined position. It should be appreciated that other means to limit the advance of the candy may also be contemplated by those of skill in the art. For example, ridges on the interior surface of the base may inhibit movement of the candy holder 100 beyond a certain point.

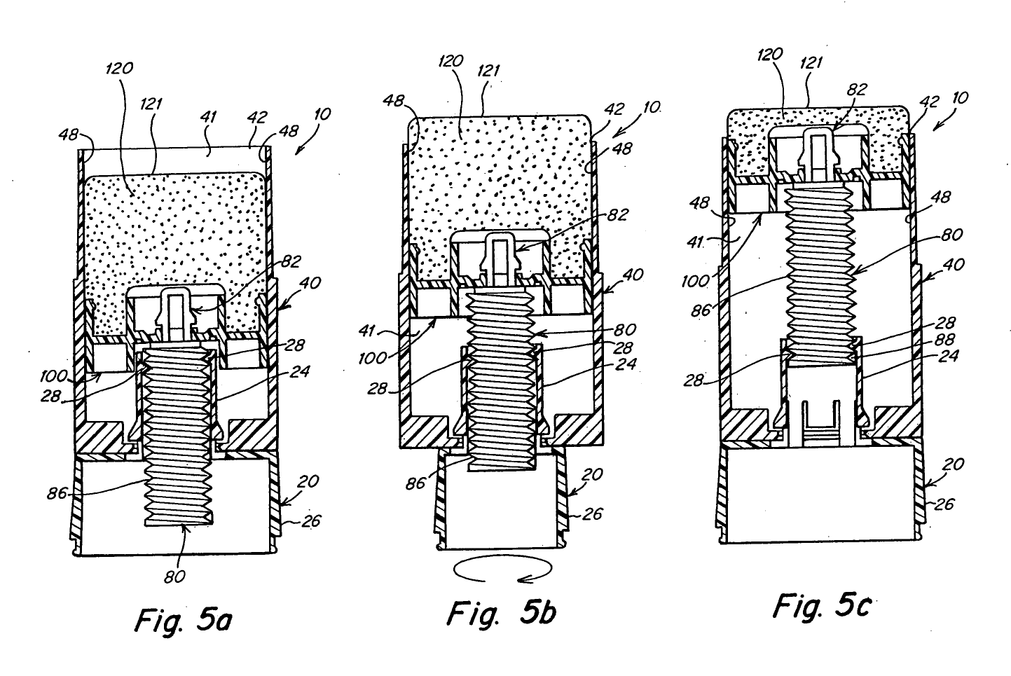

In use, candy 120 (as depicted in FIGS. 5a, 5b and 5c) is inserted into the interior portion 41 of the base 40 such that the candy 120 is supported by the candy holder 100 and contained by the side walls 48. FIG. 5a shows an embodiment of the present invention in which candy 120 is contained in the base 40 and is in a retracted position with the candy top surface 121 disposed below the top edge 42 of the base. After the candy is placed in the base, the cap 60 may be placed over the top of the base 40 to protect the candy from external sources of contamination.

To dispense the candy 120, after first removing the cap 60 from the base 40, the handle 20 is rotated relative to the base 40 in a direction that causes the threads 28 in sleeve 24 of the handle 20 to rotatably engage the threaded rod 80, causing the rod 80 to rise in the base 40 towards the top opening 42. That is, the handle 20, including the sleeve 24, rotates around the nonrotating threaded rod 80 to cause the axial force on the threaded rod 80 to move the threaded rod 80 axially toward the top opening 42 of the base 40. In this embodiment, there is no relative rotation between the base 40 and the threaded rod 80.

The candy holder 100, being connected to engaged with the threaded rod 80, likewise moves axially with the threaded rod 80 towards the top opening 42 of the base 40 without itself rotating. In this manner, candy 120 that is held on the candy holder 100 is moved in an axial direction toward the opening 42 of the base 40 as the handle 20 is rotated. By continued rotation of the handle 20, the candy 120 will be moved toward opening 42 until the candy 120 protrudes beyond the candy opening 42. FIG. 8b depicts an embodiment of the candy dispenser 10 wherein the candy 120 protrudes above the opening 42. At this point the candy 120 is ready for consumption. Continued rotation of the handle 20 will move more candy 120 beyond the opening 42, until the thread stop 88 is reached (as in FIG. 5c) to prevent further advance of the candy.

After consuming a desired quantity of the candy 120, the handle 20 may be rotated in a direction opposite the rotational direction used to dispense the candy 120 so as to retract the candy 120 into the base below the opening 42 (as in FIG. 5a). At this point, the cap 60 may be placed over the top of the base 40 to cover the opening 42 to protect the candy 120 for consumption at a later time.

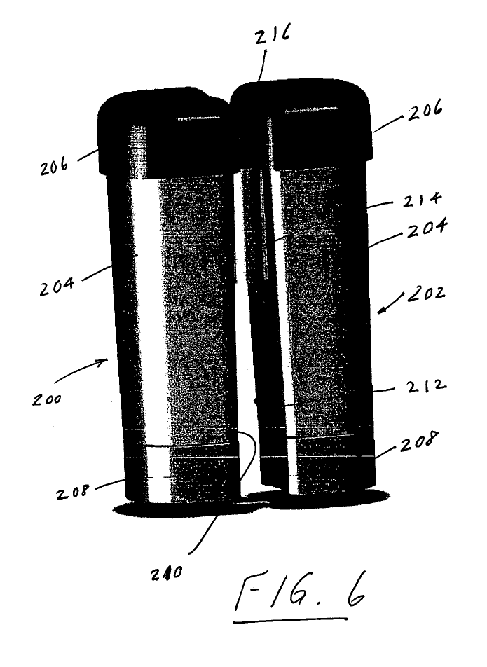

In FIGS. 6-10, another embodiment of the present invention is shown essentially composed of two dispensers 200 and 202 each having the same functional features as the dispenser 10 shown in FIGS. 1-5c. While the dispensers 200 and 202 are of a somewhat different configuration than the dispenser of FIG. 1, functionally they perform just like the dispenser 10. Thus, each dispenser has a base 204, cap 206, and handle 208. The two dispensers are essentially mirror images of one another with the opposed sides 210 and 212 having a concave face as viewed from the space between them that functionally provide room for the connectors 214 and 216 that physically connect the bases 204 and caps 206, respectively.

As shown in FIG. 9, each dispenser 200 and 202 includes a threaded rod 220 that is circular in horizontal section and engages the threads in the sleeves 222 forming part of the handles 208. Each rod 220 carries a candy holder 224 that moves up and down in the base 204 in response to axial movement of the rod 220 caused by rotation of the sleeve 222 controlled by the handle 208. The connections and operations of the mechanisms are functionally identical to that described in connection with the first embodiment.

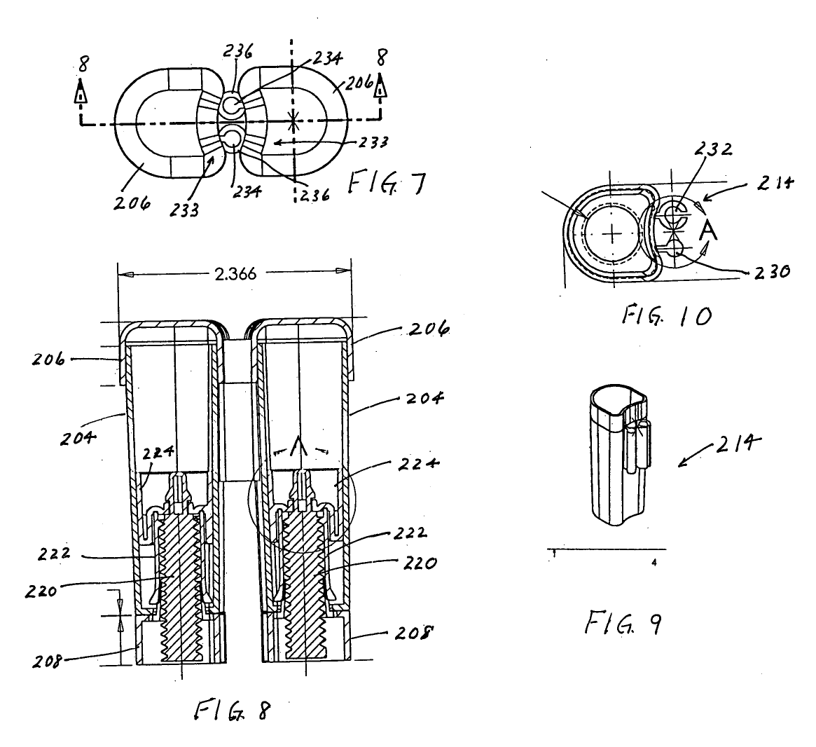

In FIGS. 9 and 10 the coupling 214 that joins the bases of the two dispensers are shown. The coupling 214 includes male and female connectors 230 and 232 that are duplicated on the concave faces 210 and 212 of the bases 204. The two bases are identical and when arranged in face-to-face relationship as shown in the assembled dispenser, the male connector 230 on one base engages the female connector on the other, and the two releasably hold the two bases connected together when they are disposed in co-extensive relationship. Similarly, as shown in FIG. 7 the caps 206 carry coupling 233, each having male and female connectors 234 an 236 that perform in the same fashion as the male and female connectors 230 and 232 mounted on the concave faces of the bases, to hold the caps 206 together.

While either connected or disconnected from one another, each dispenser 200 and 202 may operate independently of the other. For example, even while connected together, the cap 206 of one of the dispensers may be removed while the other cap remains in place by separating their couplings, and the candy may be eaten from the opened dispenser while the contents of the other is protected by the cap covering it. Alternatively, the two dispensers may be fully separated by moving one axially with respect to the other so as to slide the connectors of both pairs of couplings apart. The candy in each of the dispensers is elevated or retracted by turning the handle as described in detail in connection with the first embodiment and the upward travel of the holders may be limited by a stop on the rod and/or sleeve. The configuration of the bases and handles allow the handles to rotate on the bases even when the two are connected together as shown in FIG. 6. The concave configuration of the facing sides of the two dispensers when assembled together makes that possible.

The twin dispenser typically may be used to dispense different kinds of candy, for example, one may be a hard candy and the other a softer candy. Another typical application is to provide candies of different flavors in the two dispensers.

While the invention has been described with reference to various illustrative embodiments, the invention is not limited to the embodiments described. It is evident that many alternatives, modifications and variations of the embodiments described will be apparent to those of ordinary skill in the art. Accordingly, embodiments of the invention as set forth herein are intended to be illustrative, and not limiting the scope of the invention. Various changes may be made without departing from the scope of the invention.

What is claimed is:

1. A candy dispenser comprising:
a base having a hollow interior portion, a first end portion and a second end portion, and an axis from the first end portion to the second end portion;
a handle rotatably mounted to the base and comprising a threaded portion;
a threaded rod disposed at least partially within the base, the threaded rod operably coupled to and movable through the threaded portion in at least one axial direction wherein the threaded rod is movable in at least one axial direction relative to the base; and
a holder disposed within the hollow interior portion of the base and engaged with the threaded rod, the holder movable in at least one axial direction.

2. The candy dispenser of claim 1, wherein there is no relative rotation between the base and the rod.

3. The candy dispenser of claim 1, wherein there is no relative rotation between the holder and the rod.

4. The candy dispenser of claim 1, wherein the dispenser comprises a cap frictionally engageable with the base.

5. The candy dispenser of claim 1, wherein the holder is a movable base support for candy.

6. A candy dispenser assembly comprising:
a pair of dispensers each having a base, a handle rotatable on the base, a threaded rod movable axially in the base, a nut-like member carried with the handle, a candy holder connected to the rod, and a cap for covering candy carried by the holder,
and releasable couplings separately joining the bases and caps of the dispensers together enabling each to be used independently of the other when the bases are joined and separated from one another.

7. A candy dispenser as described in claim 6 wherein;
the handle is rotatable relative to the threaded rod.

8. A candy dispenser as described in claim 6 wherein the holder and threaded rod move axially in response to rotation of the handle.

9. A candy dispenser as described in claim 6 wherein the caps may be removed from the base independently of the other for enabling candy of one dispenser to be eaten while the other dispenser is covered.

10. A candy dispenser comprising
a base, and a handle mounted to and rotatable with respect to the base,
a threaded nut-like member connected to and rotatable together with the handle with respect to the base,
a threaded rod registering with the nut-like member and disposed on the base and moving axially in the base in response to relative rotation of the base and handle,
and a candy holder axially fixed with and connected to the rod and disposed in the base for raising candy in the holder in and out of the base.

11. The dispenser as described in claim 10 wherein the base is a container with an opening therein and the holder moves in the container toward and away from the opening in response to rotation of the handle relative to the base.

12. In combination with the dispenser as defined in claim 11,
a second like dispenser releasably attached to the first dispenser and operable independently of the first dispenser whether attached to or separated from said first container.

13. The combination of claim 12 wherein each dispenser has a cap covering the opening and removable therefrom independently of the other.

14. The combination of claim 13 wherein the caps of the dispenser are separably connected together.
